(19) United States
(12) Patent Application Publication
(10) Pub. No.: US 2024/0342039 A1
(43) Pub. Date: Oct. 17, 2024

(54) JOINT EXERCISE DEVICE AND JOINT EXERCISE METHOD USING EXERCISE EFFECT MAINTENANCE MODULE

(71) Applicant: ES HEALTHCARE INC., Seoul (KR)

(72) Inventor: Hyoung-Sik KIM, Gyeonggi-do (KR)

(21) Appl. No.: 18/294,566

(22) PCT Filed: Jun. 24, 2022
(86) PCT No.: PCT/KR2022/008989

§ 371 Date: Feb. 2, 2024

(30) Foreign Application Priority Data
Aug. 3, 2021 (KR) 10-2021-0101851

(51) Int. Cl. A61H 1/02

(52) U.S. Cl. CPC A61H 1/0277; A61H 2201/0149; A61H 2201/1671; A61H 2201/5007

(57) ABSTRACT

The present invention provides a joint exercise device and method using an exercise effect maintenance module including a joint exercise unit configured to exercise a joint portion positioned between a first portion and a second portion and including a main body part, an articulate part extending from the main body part toward the first portion and including a plurality of joints, the articulate part being configured to exercise the first portion within a preset range by moving the first portion by multiple angles relative to the joint portion, and a holding part configured to hold the first portion so that the first portion is rotated by being moved by the articulate part, and a determination unit configured to recognize a position of the joint portion based on the main body part and correct the preset range that varies depending on a variation of the joint portion.

### TECHNICAL FIELD

The present invention relates to a joint exercise device and method using an exercise effect maintenance module, and more particularly, to a joint exercise device and method using an exercise effect maintenance module that improves efficiency of a joint exercise by maintaining a rotational motion within a preset range for an exercise by consistently tracking and determining a joint position that varies when a user rotates a first portion relative to a joint portion.

### BACKGROUND ART

The human body is composed of many joints, and the joints are placed between bones. When a joint is injured or joint surgery is performed, the surrounding tissue including the tissue inside the joint is damaged, the patient experiences pain, and the radius of movement around the joint is often reduced.

In order to cope with this situation, surgical procedures are often performed on the joint portion. Further, in order to prevent the above-mentioned situation and perform rehabilitation, elderly patients with pain in joint portions or athletes who overuse their joint portions use various devices that allow the patients and athletes to exercise the joint portions in order to mitigate pain in joint portions, minimize damage to tissue of the joint portions, and improve a range of motion about the joints.

However, in general, when exercising a joint, an elderly patient or an athlete with significant joint strain will feel pain in the joint when rotating a portion of the body, such as an arm or leg, relative to the joint. In addition, the elderly patient or athlete instinctively moves the body to avoid feeling pain, which causes the joints to move together with the body.

A general exercise device for exercising the joint portion exercises the joint portion by moving the arm or leg within a predetermined range. For this reason, when the body is twisted or the joint portion is moved by the motion of the body, the joint portion cannot be exercised to a range required for the exercise, and the exercise effect is inevitably decreased significantly.

Accordingly, various methods have been proposed to improve the exercise effect by consistently performing the exercise within the predetermined range, and there is a need for means for the above-mentioned methods.

### DISCLOSURE

### Technical Problem

The present invention has been made in an effort to solve the above-mentioned problem in the related art, and an object of the present invention is to improve efficiency of a joint exercise by maintaining a rotational motion within a preset range for the exercise by consistently tracking and determining a joint position that varies when a user rotates a first portion relative to a joint portion.

Technical problems of the present invention are not limited to the aforementioned technical problems, and other technical problems, which are not mentioned above, may be clearly understood by those skilled in the art from the following descriptions.

### Technical Solution

In order to achieve the above-mentioned object, the present invention provides a joint exercise device and method using an exercise effect maintenance module including: a joint exercise unit configured to exercise a joint portion positioned between a first portion and a second portion and including a main body part, an articulate part extending from the main body part toward the first portion and including a plurality of joints, the articulate part being configured to exercise the first portion within a preset range by moving the first portion by multiple angles relative to the joint portion, and a holding part configured to hold the first portion so that the first portion is rotated by being moved by the articulate part; and a determination unit configured to recognize a position of the joint portion based on the main body part and correct the preset range that varies depending on a variation of the joint portion.

In this case, the holding part may be partially bent to define a first direction and a second direction, and the first direction and the second direction may define a preset angle based on the bent portion.

In addition, the holding part may have a direction detecting member and transfer direction information on the first and second directions based on the bent portion to the main body part.

Further, the main body part may define a reference point, and the position of the holding part may be consistently measured and transmitted to the determination unit.

Meanwhile, the joint exercise unit may further include a fixing part configured to fix the second portion to minimize a variation of a position of the joint portion while exercising the first portion.

Meanwhile, the determination unit may determine a distance between the main body part and the holding part on the basis of information transmitted from the main body part, and the determination unit may determine that the joint portion is positioned in one of the first direction and the second direction that is directed toward the reference point.

In addition, the determination unit may initially exercise the first portion by controlling the articulate part and determine a length from the bent portion of the holding part to the joint portion by means of the initial exercise.

In this case, the determination unit may determine a position of the joint portion on the basis of the direction information on the first and second directions transferred to the main body part and the length from the bent portion of the holding part to the joint portion.

Further, the determination unit may determine whether the position of the joint portion varies by consistently measuring the direction information and the position of the holding part while rotating the first portion.

In addition, the determination unit may consistently determine the position of the joint portion while the first portion is rotated relative to the joint portion by the articulate part, and when the determination unit determines that the position of the joint portion is varied, the determination unit may correct the preset range based on the varied position of the joint portion.

In this case, the joint exercise device may include: a position module on which a user is positioned to rotate a joint portion; the exercise effect maintenance module described above and disposed adjacent to the position module; and a power providing module configured to provide power for allowing the exercise effect maintenance module to rotate the joint portion.

Meanwhile, a joint exercise method uses the above-mentioned joint exercise device and includes: a determination step of determining a position of the joint portion positioned between the first portion and the second portion; an exercise step of rotating the first portion within a preset range relative to the joint portion; and a correction step of consistently correcting the preset range on the basis of the position of the joint portion that varies in accordance with an exercise.

In this case, the determination step may include: an initial process of positioning a user on the position module, mounting the holding part on the first portion of the user, and starting an initial exercise; a calculation process of calculating length information by computing a distance from the holding part to the joint portion by means of the initial exercise; a position tracking process of creating position information by consistently determining a position of the holding part based on the main body part; and a determination process of determining a position of the joint portion on the basis of the length information and the position information created by the calculation process and the position tracking process.

In this case, the calculation process may include an angle computing process of calculating a first angle between a first imaginary line, which adjoins a bent portion of the holding part, and a second imaginary line formed in one of first and second directions in which the joint portion is positioned in a state in which the holding part is bent at a preset angle so as to have the first and second directions.

In addition, the calculation process may determine, as y1 and z1, a position from the holding part to the main body part before the first portion is initially exercised in a state in which one axis is fixed, and the calculation process may divide a distance L from the bent portion of the holding part to the joint portion into a Y-axis component and a Z-axis component to recognize the first position of the joint portion.

In addition, the calculation process may specify the position of the joint portion by dividing the distance L from the bent portion of the holding part to the joint portion into the Y-axis component and the Z-axis component based on the first angle derived by the angle computing process.

In this case, the calculation process may include a variable angle computing process of rotating the first portion by a predetermined angle in an upward/downward direction and calculating a second angle between the first imaginary line and the second imaginary line.

Further, the calculation process may determine, as y2 and z2, a position from the holding part to the main body part that is varied in a state in which the first portion is moved by the second angle, and the calculation process may recognize a second position of the joint portion by dividing the distance L from the bent portion of the holding part to the joint portion into the Y-axis component and the Z-axis component by using the second angle calculated by using the variable angle computing process.

In addition, the calculation process may calculate, at the second position, a difference between the axial components at the first position, define a state in which no external force is applied in the initial exercise state, and compute the distance L from the bent portion of the holding part to the joint portion.

In this case, the calculation process may calculate the distance L from the bent portion of the holding part to the joint portion in proportion to a difference between y2 and y1.

In addition, the calculation process may calculate the distance L from the bent portion of the holding part to the joint portion in inverse proportion to a difference between the axial component at the second angle and the corresponding axial component at the first angle.

In this case, the calculation process may calculate a length of the distance L from the bent portion of the holding part to the joint portion through a Relationship Formula,

### <Relationship Formula>

$$L = \frac{{y}_{2} - {y}_{1}}{cos ( {a}_{2} ) - cos ( {a}_{1} )}$$

L: the distance from the bent portion of the holding part to the joint portion,
y₁: the position of the holding part at the first position,
y₂: the position of the holding part at the second position,
α₁: the first angle, and
α₂: the second angle.

Further, the determination process may consistently perform the calculation process and the position tracking process in the exercise step and continuously determine the position of the joint portion on the basis of the length information and the position information.

Meanwhile, the correction step may rotate the joint portion so that the holding part moves within a preset range, and the correction step may consistently correct the preset range to prevent a variation of the position of the joint portion, a variation of the preset range, and a deterioration in exercise effect.

### Advantageous Effects

According to the joint exercise device and method using the exercise effect maintenance module according to the present invention provided to achieve the above-mentioned object, it is possible to improve efficiency of the joint exercise by maintaining the rotational motion within the preset range for the exercise by consistently tracking and determining the joint position that varies when the user rotates the first portion relative to the joint portion.

The effects of the present invention are not limited to the aforementioned effects, and other effects, which are not mentioned above, will be clearly understood by those skilled in the art from the claims.

### DESCRIPTION OF DRAWINGS

A detailed description of the exemplary embodiments of the present application to be described below as well as the summary explained above will be understood well when reading the detailed description and the summary with reference to the accompanying drawings.

The exemplary embodiments are illustrated in the drawings for the purpose of exemplifying the present invention.

However, it should be understood that the present application is not limited to the illustrated exact arrangement and means.

FIG. 1 is a view for explaining a schematic configuration of a joint exercise device and method using an exercise effect maintenance module according to an embodiment of the present invention.

FIG. 2 is a view illustrating a state in which a user is seated on the joint exercise device for performing the joint exercise method using the exercise effect maintenance module according to the embodiment of the present invention.

FIG. 3 is a view for explaining the joint exercise method using the joint exercise device using the exercise effect maintenance module according to the embodiment of the present invention.

FIG. 4 is a view illustrating a determination step of the joint exercise method using the joint exercise device using the exercise effect maintenance module according to the embodiment of the present invention.

FIG. 5 is a view for explaining a calculation process of the joint exercise method using the joint exercise device using the exercise effect maintenance module according to the embodiment of the present invention.

FIG. 6 is a view for explaining a holding part of the joint exercise device for performing the joint exercise method using the exercise effect maintenance module according to the embodiment of the present invention.

FIG. 7 is a view for explaining an initial process of the joint exercise method using the joint exercise device using the exercise effect maintenance module according to the embodiment of the present invention.

FIG. 8 is a view for explaining a first position of the joint exercise device for performing the joint exercise method using the exercise effect maintenance module according to the embodiment of the present invention.

FIG. 9 is a view for explaining a second position of the joint exercise device for performing the joint exercise method using the exercise effect maintenance module according to the embodiment of the present invention.

FIG. 10 is a view for explaining a situation in which a joint portion varies in accordance with the joint exercise device and method using the exercise effect maintenance module according to the embodiment of the present invention.

### EXPLANATION OF REFERENCE NUMERALS AND SYMBOLS

θ: Preset angle
A: First portion
B: Second portion
α1: First angle
α2: Second angle
L1: First imaginary line
L2: Second imaginary line
J: Joint portion
S1: First position
S2: Second position
S10: Determination step
S12: Initial process
S14: Calculation process
S142: Angle computing process
S144: Variable angle computing process
S16: Position tracking process
S18: Determination process
S20: Exercise step
S30: Correction step
T1: First direction
T2: Second direction
100: Position module
222: Main body part
224: Articulate part
226: Holding part
228: Fixing part

### BEST MODE

Hereinafter, exemplary embodiments of the present invention for specifically accomplishing the objects of the present invention will be described with reference to the accompanying drawings.

In the description of the present embodiments, like terms and like reference numerals are used for like configurations, and additional descriptions for the like configurations will be omitted.

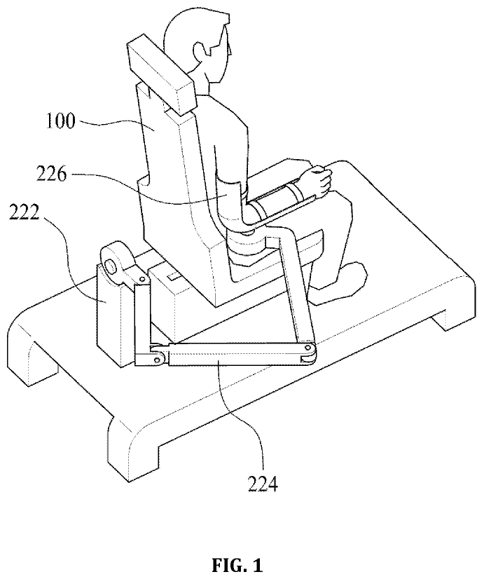

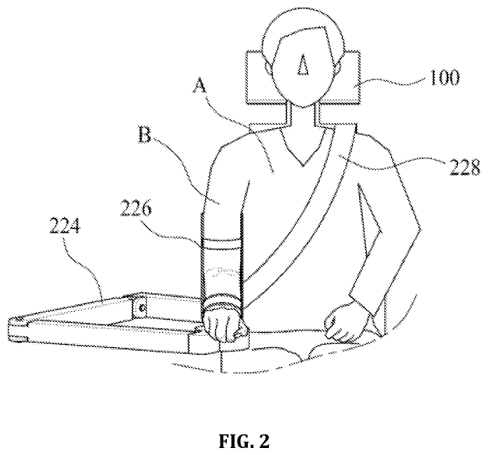

First, a schematic configuration and shape of a joint exercise device and method using an exercise effect maintenance module according to an embodiment of the present invention will be described with reference to FIGS. 1 and 2.

Specifically, FIG. 1 is a view for explaining a schematic configuration of a joint exercise device and method using an exercise effect maintenance module according to an embodiment of the present invention, and FIG. 2 is a view illustrating a state in which a user is seated on the joint exercise device for performing the joint exercise method using the exercise effect maintenance module according to the embodiment of the present invention.

First, as illustrated in FIG. 1, the joint exercise device using the exercise effect maintenance module according to the embodiment of the present invention may include a position module 100 configured to provide a space in which a user is seated and rotates a joint portion J, the exercise effect maintenance module disposed adjacent to the position module 100, and a power providing module configured to provide power to allow the exercise effect maintenance module to rotate the joint portion J.

In this case, the position module 100 may be provided in the form of a general chair and formed to conform to first and second portions A and B of the user's body.

For example, in case that the user's joint portion J is a shoulder joint, the position module 100 may be provided in the form of a general chair. In case that the user's joint portion J is a knee joint, the position module 100 may be configured such that the user is seated on the position module 100, the user's shin corresponding to the first portion A is freely rotatable, and the user's thigh corresponding to the second portion B is seated.

Meanwhile, the exercise effect maintenance module may include a joint exercise unit configured to exercise the joint portion J positioned between the user's first and second portions A and B, and a determination unit configured to recognize a position of the joint portion J and correct a preset range that varies depending on the variation of the position of the joint portion J.

In this case, the joint exercise unit may include a main body part 222 configured to define a reference point, an articulate part 224 extending from the main body part 222 toward the first portion A and including a plurality of joints, the articulate part 224 being configured to rotate the first portion A within the preset range by moving the first portion A by multiple angles relative to the joint portion J, a holding part 226 configured to hold the first portion A so that the first portion A is rotated by being moved by the articulate part 224, and a fixing part 228 configured to minimize a variation of a position of the joint portion J by minimizing the motion of the second portion B while rotating the first portion A.

In this case, the main body part 222 may define the reference point based on which the determination unit recognizes the position of the joint portion J.

In addition, the articulate part 224 may connect the main body part 222 and the holding part 226 and exercise the joint portion J by moving the holding part 226 by multiple angles.

Meanwhile, the holding part 226 may be formed to correspond to the first portion and bent by a preset angle θ to define a first direction T1 and a second direction T2 in order to specify the position of the joint portion J. A direction detecting member may be provided to specify the first direction T1 and the second direction T2 based on the bent portion. The determination unit may recognize a position, at which the holding part 226 is spaced apart from the main body part 222, by transferring information about the first direction T1 and the second direction T2 to the main body part 222. The position of the joint portion J may be specified on the basis of direction information about the first direction T1 and the second direction T2.

This configuration will be described more specifically with reference to the drawings to be described in detail below.

Meanwhile, as illustrated in FIG. 2, the fixing part 228 may fix the second portion B within a range in which the fixing part 228 is not in contact with the joint portion J intended to be exercised.

For example, the fixing part 228 may be provided in the form of a single belt extending from the shoulder at one side to the waist or provided in the form of two belts extending from the shoulders at two opposite sides to the two waist portions. The fixing part 228 may be configured to surround the second portion B to fix an upper or lower body. However, the present invention is not necessarily limited to the described shape, and the fixing part 228 may be variously modified to any shape as long as the fixing part 228 may fix the second portion B and minimize the motion of the joint portion B.

Meanwhile, as described above, the determination unit may determine the direction information, which is transferred from the main body part 222, and a distance between the holding part 226 and the reference point defined by the main body part 222. The determination unit may determine that the joint portion J is positioned in one of the first direction T1 and the second direction T2 that is directed toward the reference point.

Further, the determination unit may control the articulate part 224 to initially initial exercise the first portion A and determine a length from the bent portion of the holding part 226 to the joint portion J by means of the initial exercise.

Because the direction of the joint portion J is specified on the basis of the direction information, the position of the joint portion J may be specified by calculating a distance to the joint portion J in order to specify the position of the joint portion J. Therefore, it is possible to consistently measure a distance between the main body part 222 and the holding part 226 and consistently determine the position of the joint portion J on the basis of the distance calculated on the basis of the information on the first direction T1 and the second direction T2 consistently transferred from the holding part 226.

Therefore, even though the position of the joint portion J varies, the preset range in which the user needs to exercise may be corrected on the basis of changed joint portion J, such that the user may exercise within an accurate range, which may improve the exercise effect.

However, the preset range described in the detailed description of the present invention may include all the upward/downward directions and the leftward/rightward directions. The preset range made before the position of the joint portion J varies may be substantially identical in size to the preset range made after the position of the joint portion J varies. However, assuming that an exercise range is set to an end point of the preset range based on the joint portion J and the end point of the preset range at an initial position is identical to the position of the end point after the joint portion J varies, the user exercises within a range narrower than the preset range within which the user needs to substantially move.

Therefore, the range is corrected based on the joint position J, such that the user may exercise in the state in which the preset range is maintained. The preset range may mean a distance and range to the position of the end point at which the first portion A is rotated relative to the joint portion J.

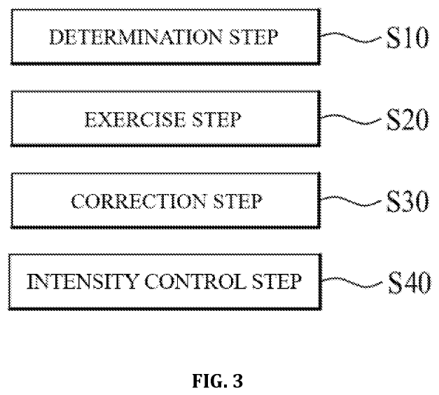

Meanwhile, the joint exercise method using the joint exercise device according to the embodiment of the present invention may be briefly described with reference to FIGS. 3 to 5.

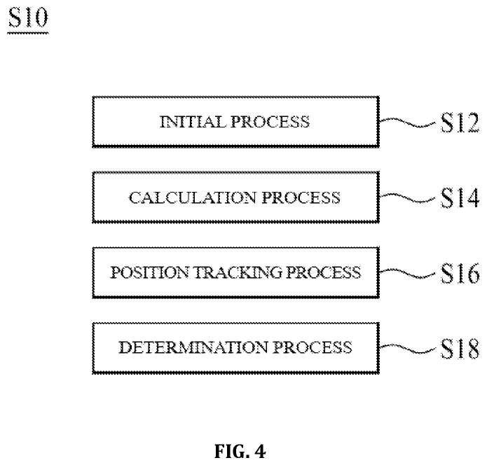

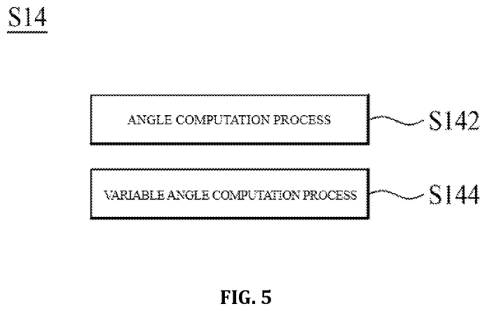

Specifically, FIG. 3 is a view for explaining the joint exercise method using the joint exercise device using the exercise effect maintenance module according to the embodiment of the present invention, FIG. 4 is a view illustrating a determination step of the joint exercise method using the joint exercise device using the exercise effect maintenance module according to the embodiment of the present invention, and FIG. 5 is a view for explaining a calculation process of the joint exercise method using the joint exercise device using the exercise effect maintenance module according to the embodiment of the present invention.

First, as illustrated in FIG. 3, the joint exercise method using the joint exercise device according to the embodiment of the present invention may include a determination step S10 of determining the position of the joint portion J positioned between the first portion A and the second portion B, an exercise step S20 of rotating the first portion A within the preset range relative to the joint portion J, and a correction step S30 of consistently correcting the preset range on the basis of the position of the joint portion J that varies in accordance with the exercise.

First, the determination step S10 may be a step of specifying the position of the joint portion J. The determination step S10 may include an initial process S12, a calculation process S14, a position tracking process S16, and a determination process S18.

In this case, the initial process S12 may be a process of performing an initial exercise by mounting the holding part 226 on the first portion A in order to specify the position of the joint portion J positioned between the first portion A and the second portion B.

In this case, the initial exercise performed in the initial process S12 may be an exercise that varies the position of the first portion A in a state in which one axis is fixed. Representatively, it is possible to determine a distance of the bent portion of the holding part 226 along a Y-axis in the forward/rearward direction while changing a Z-axis in the upward/downward direction in a state in which an X-axis in the leftward/rightward direction is fixed.

As described above, the calculation process S14 of calculating the distance from the bent portion of the holding part 226 to the joint portion J may be performed while the initial process S12 is performed.

In this case, the calculation process S14 will be described more specifically below with reference to the drawings to be described in detail. The length information about the length to the joint portion J may be calculated on the basis that the position of the bent portion of the holding part 226 varies depending on the motion of the first portion A in the upward/downward direction.

In addition, as illustrated in FIG. 5, the calculation process S14 may include an angle computing process S141 of calculating a first angle α1 between a first imaginary line L1, which is parallel to the Y-axis in the forward/rearward direction that adjoins the bent portion of the holding part 226, and a second imaginary line L2, which is parallel to any one of the first direction T1 and the second direction T2 in which the joint portion J is positioned, in a state in which the holding part 226 is bent at the preset angle θ so as to have the first direction T1 and the second direction T2, and a variable angle computing process S142 of rotating the first portion A by a predetermined angle in the Z-axis direction, which is the upward/downward direction, and calculating a second angle α2 between the first imaginary line L1 and the second imaginary line L2.

Meanwhile, the position tracking process S16 may create information about the position of the holding part 226 by consistently determining the position of the holding part 226 based on the main body part 222.

In addition, the determination process S18 may specify the position of the joint portion J on the basis of the length information and the position information created by the calculation process S14 and the position tracking process S16.

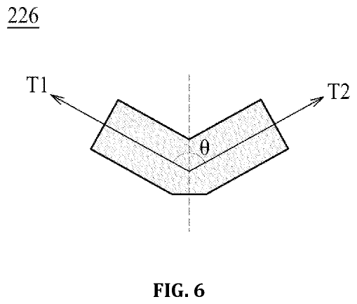

The above-mentioned joint exercise method may be more specifically described with reference to FIGS. 6 to 10.

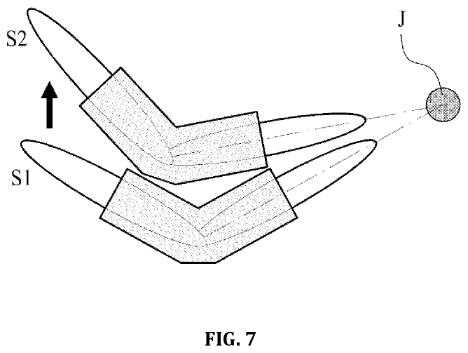

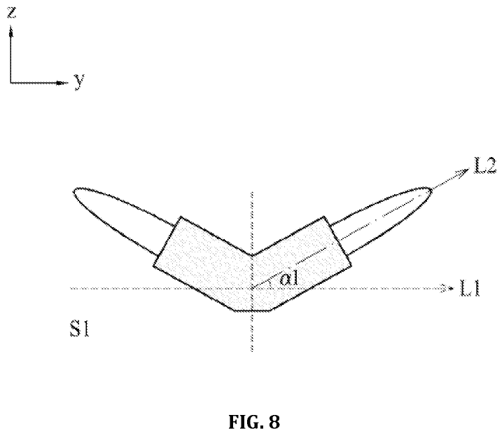

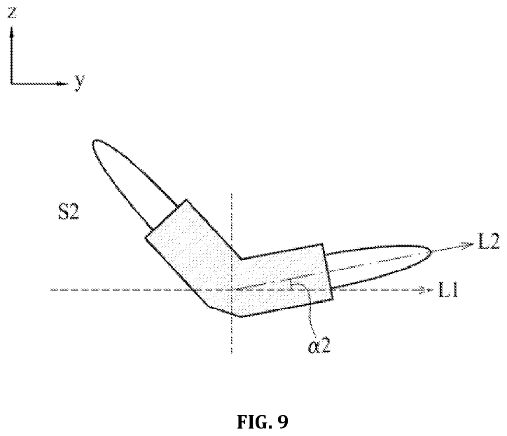

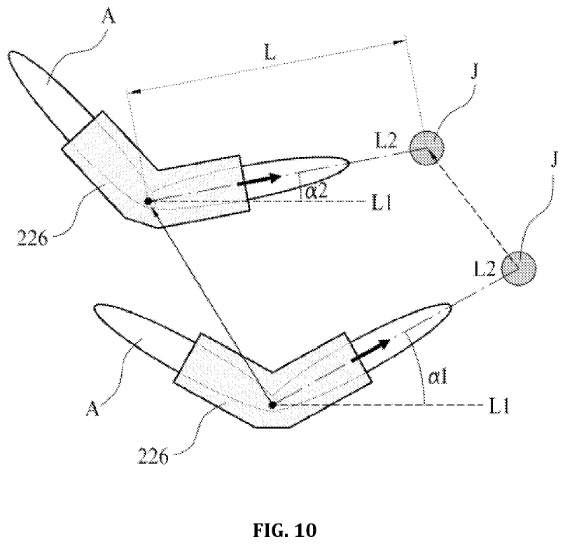

Specifically, FIG. 6 is a view for explaining the holding part of the joint exercise device for performing the joint exercise method using the exercise effect maintenance module according to the embodiment of the present invention, FIG. 7 is a view for explaining an initial process of the joint exercise method using the joint exercise device using the exercise effect maintenance module according to the embodiment of the present invention, FIG. 8 is a view for explaining a first position of the joint exercise device for performing the joint exercise method using the exercise effect maintenance module according to the embodiment of the present invention, FIG. 9 is a view for explaining a second position of the joint exercise device for performing the joint exercise method using the exercise effect maintenance module according to the embodiment of the present invention, and FIG. 10 is a view for explaining a situation in which the joint portion varies in accordance with the joint exercise device and method using the exercise effect maintenance module according to the embodiment of the present invention.

First, as illustrated in FIG. 6, the holding part 226 may be bent to have the preset angle θ, and the two directions in which the holding part 226 is bent may be directed toward the different first and second directions T1 and T2.

In this case, one side surface of the holding part 226 may be made of a material having rigidity to define the first direction T1 and the second direction T2, and the other side surface of the holding part 226 may be made of a flexible material so as to be mounted on the first portion A.

As described above, because the first direction T1 and the second direction T2 of the holding part 226 are particularly determined, it is possible to determine that the joint portion J is positioned in one of the first direction T1 and the second direction T2, which is directed toward the main body part 222, on the basis of the position information for determining the position of the holding part 226 from the main body part 222 and the direction information transferred from the holding part 226 to the main body part 222.

As illustrated in FIG. 7, the initial process S12 may be performed by controlling the joint exercise device on the basis of the above-mentioned configuration.

In this case, because an actual operation of the device moves three-dimensionally, it is assumed that no motion is made in the X-axis direction in order to provide a simple example. In a state in which a length L from the bent portion of the holding part 226 to the joint portion J is fixed in the X-axis direction, i.e., the leftward/rightward direction, the holding part 226 is rotated in the upward/downward direction relative to the joint portion J, such that only a Y-axis value and a Z-axis value may be changed.

Therefore, the distance from the main body part 222 to the holding part 226 may be divided into a Y-axis component and a Z-axis component, and the axial components may be determined as y1 and z1. In the state in which the first angle α1 between the first imaginary line L1 and the second imaginary line L2 is calculated, the length L from the bent portion of the holding part 226 to the joint portion J may be divided into the Y-axis component and the Z-axis component.

That is, the length L, which has any unknown value, may be divided into the Y-axis component and the Z-axis component, such that the position of the joint portion J may be arbitrarily specified, and any position of the joint portion J, which is calculated by a related equation, may be determined as a first position S1.

In addition, as illustrated in FIG. 7, the second angle α2 is calculated in a similar way to the calculation of the first angle α1 in the state in which the first portion A is raised by a predetermined angle in the upward/downward direction relative to the joint portion J. In this case, the position of the holding part 226 may be divided into a Y-axis component and a Z-axis component based on the main body part 222, and the Y-axis component and the Z-axis component are determined as y2 and z2. Because any length L is fixed based on the second angle α2, a second position S2 of the joint portion J may be determined by means of a related equation.

In more detail, as illustrated in FIG. 8, in case that the direction of the main body part 222 at the first position S1 is determined as being positioned in the second direction T2 based on FIG. 6, the first imaginary line L1 may define an imaginary line parallel to the Y-axis, the second imaginary line L2 may be defined in the second direction T2, and the first angle α1 between the first imaginary line L1 and the second imaginary line L2 may be determined.

Based on this configuration, the distance from the main body part 222 to the holding part 226 is y1 on the Y-axis, and the Y-axis component with respect to the length L is L cos(α1). Therefore, except for a value of L cos(α1) on y1, the position on the Y-axis is determined at the first position S1 of the joint portion J. Even in the case of the Z-axis, the joint portion J may be specified at the first position S1 by performing the above-mentioned method.

The above-mentioned configuration may be more conveniently computed by Equation 1 below.

$${S}_{1} = {y}_{1} - L cos ( {a}_{1} ) \qquad ( Equation 1 )$$

As described above, when the equation related to the first position S1 is defined, an equation related to the second position S2 may be defined in a similar way by moving the first portion A by a predetermined angle in the upward/downward direction, as illustrated in FIG. 9.

In this case, as illustrated in FIG. 9, the first imaginary line L1 is parallel to the Y-axis, like at the first position S1. Because the position of the holding part 226 has moved in the upward/downward direction on the Z-axis, the second angle α2 may have a different value from the first angle α1.

Therefore, like the above-mentioned equation of the first position S1, an equation related to the second position S2 may be defined as Equation 2 below.

$${S}_{2} = {y}_{2} - L cos ( {a}_{2} ) \qquad ( Equation 2 )$$

However, in this case, in a state in which no external force is applied, i.e., the position of the joint portion J does not vary, the first position S1 and the second position S2 have practically the same position value, such that Expression 3 below may be obtained by establishing a formula indicating that Equation 1 and Equation 2 are identical to each other.

$$L = \frac{{y}_{2} - {y}_{1}}{cos ( {a}_{2} ) - cos ( {a}_{1} )} \qquad ( Expression 3 )$$

Since this process also calculates the Z-axis component, the Lz value can also be calculated as a result, and thus the L value can be specified through the Ly and Lz components.

Therefore, in the determination process S18, the position of the joint portion J may be specified on the basis of information on the length of value L obtained by the calculation process S14, information on the position of the holding part 226, and information on the direction of the holding part 226. Therefore, it is possible to form a criterion based on which the joint portion J may be consistently determined.

In case that the position of the joint portion J is specified by the determination step S10 as described above, the exercise step S20 of rotating the first portion A to exercise the joint portion J may be performed.

However, when the joint position J is varied by pain or discomfort during the exercise step S20, as illustrated in FIG. 10, the preset range may fluctuate, and the exercise effect may deteriorate. Therefore, the correction step S30 of correcting the preset range by consistently determining the position of the joint portion J while performing the exercise step S20 may be performed.

In this case, the correction step S30 may determine the varied joint position J by consistently performing the determination process S18 even in the exercise step S20 and correct the preset range by increasing or decreasing a degree to which the joint position J varies relative to the end point at which the holding part 226 moves within the preset range.

It is possible to efficiently improve the exercise effect by always maintaining the end point at which the first portion A rotates relative to the joint position J even though the position of the joint portion J varies. Because the measurement is repeatedly performed while the position is consistently tracked, it is possible to effectively determine the range of the joint exercise.

While the exemplary embodiments according to the present invention have been described above, it is obvious to those skilled in the art that the present invention may be specified in other particular forms in addition to the aforementioned embodiments without departing from the spirit or the scope of the present invention.

Accordingly, it should be understood that the aforementioned embodiments are not restrictive but illustrative, and thus the present invention is not limited to the aforementioned description, and may be modified within the scope of the appended claims and the equivalent range thereto.

1. An exercise effect maintenance module comprising:
a joint exercise unit configured to exercise a joint portion positioned between a first portion and a second portion and including a main body part, an articulate part extending from the main body part toward the first portion and including a plurality of joints, the articulate part being configured to exercise the first portion within a preset range by moving the first portion by multiple angles relative to the joint portion, and a holding part configured to hold the first portion so that the first portion is rotated by being moved by the articulate part; and
a determination unit configured to recognize a position of the joint portion based on the main body part and correct the preset range that varies depending on a variation of the joint portion.

2. The exercise effect maintenance module of claim 1, wherein the holding part is partially bent to define a first direction and a second direction, and the first direction and the second direction define a preset angle based on the bent portion.

3. The exercise effect maintenance module of claim 2, wherein the holding part has a direction detecting member and transfers direction information on the first and second directions based on the bent portion to the main body part.

4. The exercise effect maintenance module of claim 3, wherein the main body part defines a reference point, and the position of the holding part is consistently measured and transmitted to the determination unit.

5. The exercise effect maintenance module of claim 1, wherein the joint exercise unit further includes a fixing part configured to fix the second portion to minimize a variation of a position of the joint portion while exercising the first portion.

6. The exercise effect maintenance module of claim 4, wherein the determination unit determines a distance between the main body part and the holding part on the basis of information transmitted from the main body part, and the determination unit determines that the joint portion is positioned in one of the first direction and the second direction that is directed toward the reference point.

7. The exercise effect maintenance module of claim 6, wherein the determination unit initially exercises the first portion by controlling the articulate part and determines a length from the bent portion of the holding part to the joint portion by means of the initial exercise.

8. The exercise effect maintenance module of claim 7, wherein the determination unit determines a position of the joint portion on the basis of the direction information on the first and second directions transferred to the main body part and the length from the bent portion of the holding part to the joint portion.

9. The exercise effect maintenance module of claim 8, wherein the determination unit determines whether the position of the joint portion varies by consistently measuring the direction information and the position of the holding part while rotating the first portion.

10. The exercise effect maintenance module of claim 8, wherein the determination unit consistently determines the position of the joint portion while the first portion is rotated relative to the joint portion by the articulate part, and
wherein when the determination unit determines that the position of the joint portion is varied, the determination unit corrects the preset range based on the varied position of the joint portion.

11. A joint exercise device comprising:
a position module on which a user is positioned to rotate a joint portion;
the exercise effect maintenance module of claim 1 disposed adjacent to the position module; and
a power providing module configured to provide power for allowing the exercise effect maintenance module to rotate the joint portion.

12. A joint exercise method, which uses the joint exercise device of claim 11, the joint exercise method comprising:
a determination step of determining a position of the joint portion positioned between the first portion and the second portion;
an exercise step of rotating the first portion within a preset range relative to the joint portion; and
a correction step of consistently correcting the preset range on the basis of the position of the joint portion that varies in accordance with an exercise.

13. The joint exercise method of claim 12, wherein the determination step comprises:
an initial process of positioning a user on the position module, mounting the holding part on the first portion of the user, and starting an initial exercise;
a calculation process of calculating length information by computing a distance from the holding part to the joint portion by means of the initial exercise;
a position tracking process of creating position information by consistently determining a position of the holding part based on the main body part; and
a determination process of determining a position of the joint portion on the basis of the length information and the position information created by the calculation process and the position tracking process.

14. The joint exercise method of claim 13, wherein the calculation process comprises an angle computing process of calculating a first angle between a first imaginary line, which adjoins a bent portion of the holding part, and a second imaginary line formed in one of first and second directions in which the joint portion is positioned in a state in which the holding part is bent at a preset angle so as to have the first and second directions.

15. The joint exercise method of claim 14, wherein the calculation process determines, as y1 and z1, a position from the holding part to the main body part before the first portion is initially exercised in a state in which one axis is fixed, and the calculation process divides a distance L from the bent portion of the holding part to the joint portion into a Y-axis component and a Z-axis component to recognize the first position of the joint portion.

16. The joint exercise method of claim 15, wherein the calculation process specifies the position of the joint portion by dividing the distance L from the bent portion of the holding part to the joint portion into the Y-axis component and the Z-axis component based on the first angle derived by the angle computing process.

17. The joint exercise method of claim 15, wherein the calculation process comprises a variable angle computing process of rotating the first portion by a predetermined angle in an upward/downward direction and calculating a second angle between the first imaginary line and the second imaginary line.

18. The joint exercise method of claim 17, wherein the calculation process determines, as y2 and z2, a position from the holding part to the main body part that is varied in a state in which the first portion is moved by the second angle, and the calculation process recognizes a second position of the joint portion by dividing the distance L from the bent portion of the holding part to the joint portion into the Y-axis component and the Z-axis component by using the second angle calculated by using the variable angle computing process.

19. The joint exercise method of claim 18, wherein the calculation process calculates, at the second position, a difference between the axial components at the first position, defines a state in which no external force is applied in the initial exercise state, and computes the distance L from the bent portion of the holding part to the joint portion.

20. The joint exercise method of claim 19, wherein the calculation process calculates the distance L from the bent portion of the holding part to the joint portion in proportion to a difference between y2 and y1.

21. The joint exercise method of claim 20, wherein the calculation process calculates the distance L from the bent portion of the holding part to the joint portion in inverse proportion to a difference between the axial component at the second angle and the corresponding axial component at the first angle.

22. The joint exercise method of claim 21, wherein the calculation process calculates a length of the distance L from the bent portion of the holding part to the joint portion through a Relationship Formula,
<Relationship Formula>
$$L = \frac{{y}_{2} - {y}_{1}}{cos ( {a}_{2} ) - cos ( {a}_{1} )}$$
L: the distance from the bent portion of the holding part to the joint portion,
y₁: the position of the holding part at the first position,
y₂: the position of the holding part at the second position,
α₁: the first angle, and
α₂: the second angle.

23. The joint exercise method of claim 13, wherein the determination process consistently performs the calculation process and the position tracking process in the exercise step and continuously determines the position of the joint portion on the basis of the length information and the position information.

24. The joint exercise method of claim 12, wherein the correction step rotates the joint portion so that the holding part moves within a preset range, and the correction step consistently corrects the preset range to prevent a variation of the position of the joint portion, a variation of the preset range, and a deterioration in exercise effect.
